(19) United States
(12) Patent Application Publication
(10) Pub. No.: US 2013/0151571 A1
(43) Pub. Date: Jun. 13, 2013

(54) INTERFACE DEFINED VIRTUAL DATA FIELDS

(71) Applicants: Dirk Stumpf, Graben-Neudorf (DE); Rene Gross, Heidelberg (DE); Tim Kornmann, Wiesloch (DE); Gerd Ritter, Heidelberg (DE)

(72) Inventors: Dirk Stumpf, Graben-Neudorf (DE); Rene Gross, Heidelberg (DE); Tim Kornmann, Wiesloch (DE); Gerd Ritter, Heidelberg (DE)

(73) Assignee: SAP AG, Walldorf (DE)

(21) Appl. No.: 13/313,975

(22) Filed: Dec. 7, 2011

(51) Int. Cl. G06F 7/00

(52) U.S. Cl. 707/805; 707/E17.044

(57) ABSTRACT

According to one general aspect, a method may include receiving a virtual data field definition from a user interface model. The virtual data field may include a data field does not have a counterpart in a database of actual data fields. The method may include dynamically generating the virtual data field based upon the virtual data field definition. The method may include responding to a data request from the user interface with a plurality of data fields, wherein the plurality of data fields include both the virtual data field and an actual data field included by the database.

### TECHNICAL FIELD

This description relates to the processing and dissemination of information.

### BACKGROUND

In the area of client/server computing, often client-related data is stored on a server. The client/server interaction is typically referred to as a “session” or “data session”. The data created, modified, or associated with this session is often referred to as “session data”. The session and the session data are traditionally associated with a lifetime or period of time in which the session data will be maintained even though no activity occurs from the client. The lifetime of that data is mostly limited for various reasons, for example, security concerns, to reduce the amount of required resources consumed by maintaining the data, etc. After the time of inactivity with the client has exceeded this lifetime period, the client's session is generally terminated and the associated session data are dis-associated (e.g., deleted, etc.) with the session and the client. These session data represent the client's view of data provided by backend services.

Frequently, the data provided by the server or backend databases will not necessarily meet the demands of various user interface (UI) or client needs. Data provided by the server or backend databases is often designed to reflect the attributes and behavior of the entities that created the data (e.g., Enterprise resource planning (ERP), Customer relationship management (CRM), etc.). As such, the data is often created without regard to the usefulness of the data within the client user interface. Frequently, the data is adapted or altered in order to be suitable for the client user interface. Today this mostly happens programmatically. Model driven approaches are generally limited to only combine and rearrange the data provided by the data services.

Often the desire for the client user interface to change or alter the backend data can cause various difficulties. For example, the backend data or database typically includes hundreds or thousands of entries. This data will need to be processed either by the backend server or device, or by the client user interface or device. If the backend data is not suitable for the client user interface, often the hundreds or thousands entries in the backend data must be transferred to the client for processing. This immense data transfer is not desirable.

### SUMMARY

According to one general aspect, a method may include receiving a virtual data field definition from a user interface model. The virtual data field may include a data field does not have a counterpart in a database of actual data fields. The method may include dynamically generating the virtual data field based upon the virtual data field definition. The method may include responding to a data request from the user interface with a plurality of data fields, wherein the plurality of data fields include both the virtual data field and an actual data field included by the database.

According to another general aspect, an apparatus may include a network interface and a processor. The network interface may be configured to receive a virtual data field definition from a user interface model, wherein the virtual data field includes a data field that does not have a counterpart in a database of actual data fields. The processor may be configured to dynamically generate the virtual data field based upon the virtual data field definition, and respond to a data request from the user interface with a plurality of data fields, wherein the plurality of data fields include both the virtual data fields and actual data fields included by the database.

According to another general aspect, a computer program product for providing information. The computer program product may be tangibly embodied on a computer-readable medium and include executable code. When executed the executable code, may be configured to cause a data processing apparatus to receive a virtual data field definition from a user interface model, wherein the virtual data field includes a data field does not have a counterpart in a database of actual data fields. When executed the executable code, may be configured to cause a data processing apparatus to dynamically generate the virtual data field based upon the virtual data field definition. When executed the executable code, may be configured to cause a data processing apparatus to respond to a data request from the user interface with a plurality of data fields, wherein the plurality of data fields include both the virtual data fields and actual data fields included by the database.

The details of one or more implementations are set forth in the accompanying drawings and the description below. Other features will be apparent from the description and drawings, and from the claims.

A system and/or method for processing information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a screenshot of an example embodiment of a user interface in accordance with the disclosed subject matter.

FIG. 4 is a screenshot of an example embodiment of a user interface in accordance with the disclosed subject matter.

FIG. 5 is a screenshot of an example embodiment of a user interface in accordance with the disclosed subject matter.

FIG. 6 is a screenshot of an example embodiment of a data structure in accordance with the disclosed subject matter.

FIG. 7 is a flowchart of an example embodiment of a technique in accordance with the disclosed subject matter.

Like reference symbols in the various drawings indicate like elements.

### DETAILED DESCRIPTION

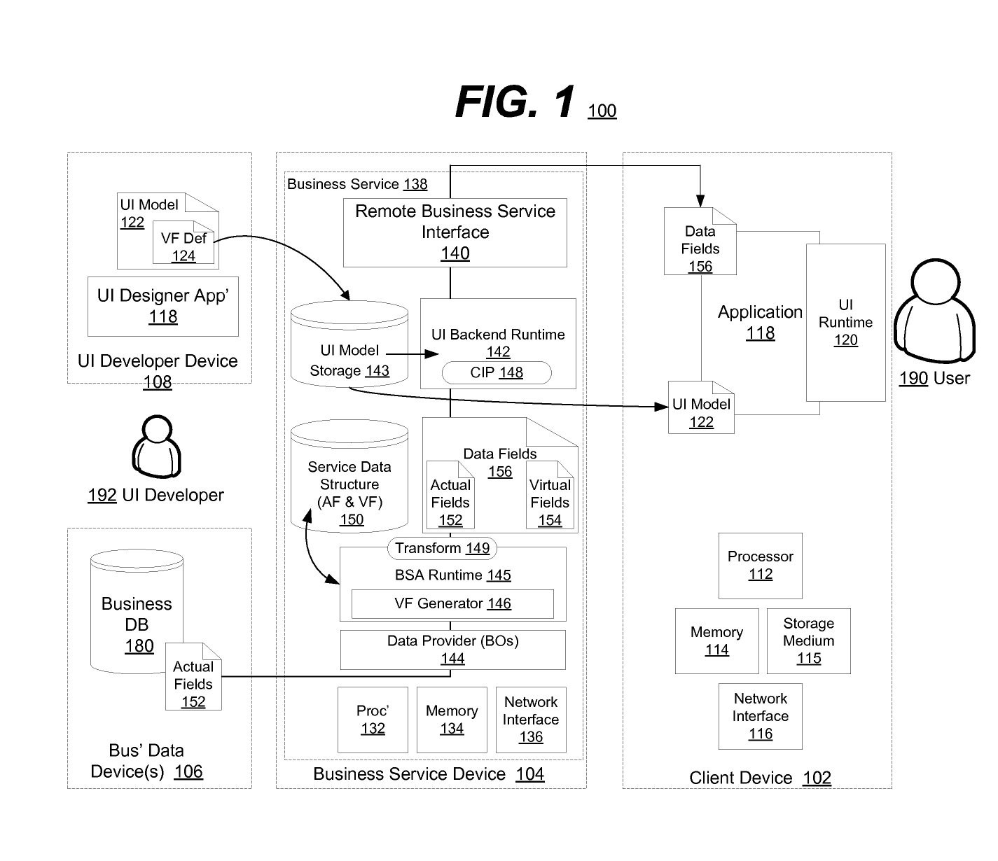

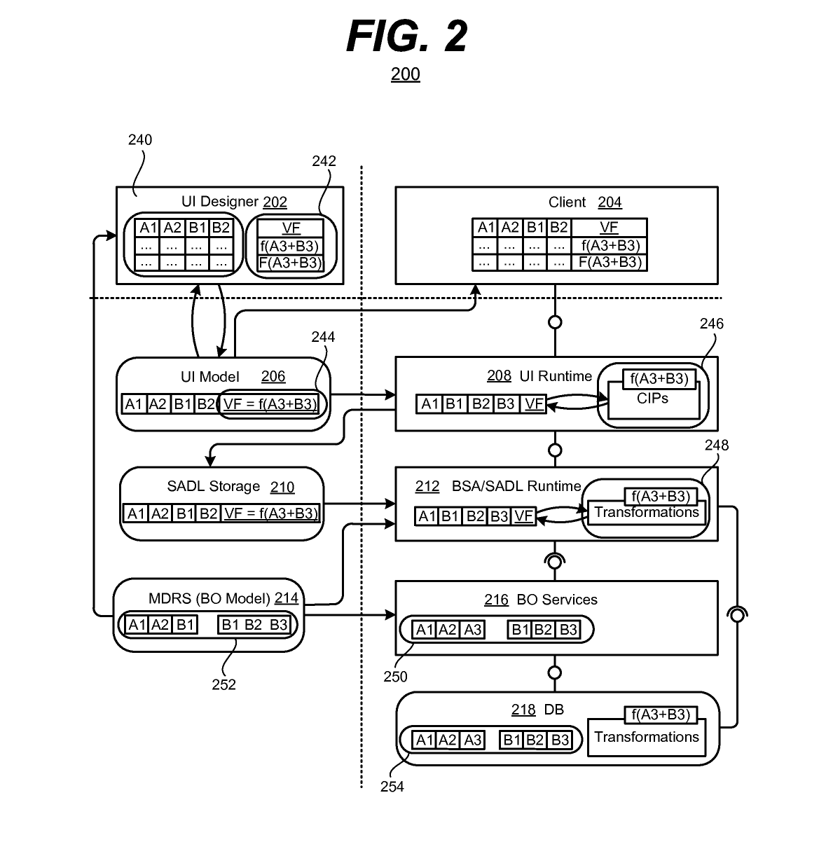

FIG. 1 is a block diagram of an example embodiment of a system 100 in accordance with the disclosed subject matter. The system 100 shows one rather generic embodiment of the disclosed subject matter. Another more specific embodiment of the disclosed subject matter is show in FIG. 2 and described in more detail below. It is understood that the above are merely a few illustrative examples to which the disclosed subject matter is not limited.

In the illustrated embodiment, the system 100 may include a client computing device 102 that is used by a user 190. This client device 102 may access a business service 140 or a business service device 104 via a communications network. This business service device 104 may provide the backend or server portion of an application, often for use in a business, such as, for example, Supplier Relationship Management (SRM), Product Lifecycle Management (PLM), Supply Chain Management (SCM), Customer relationship management (CRM), Enterprise resource planning (ERP), etc. It is understood that the above are merely a few illustrative examples to which the disclosed subject matter is not limited.

In various embodiments, the client device 102 may include a computing device, such as, for example, a shared computing terminal, a thin client, a desktop personal computer, a laptop, a netbook, a tablet, a smartphone, etc. or a virtual machine thereof. In various embodiments, the client device 102 may be used by a user 190. In various embodiments, the computing device 102 may include a processor 112 configured to execute one or more machine executable instructions or pieces of software, firmware, or a combination thereof. The computing device 102 may include, in some embodiments, a memory 114 configured to store on or more pieces of data, either temporarily, permanently, semi-permanently, or a combination thereof. Further, the memory 114 may include volatile memory, non-volatile memory or a combination thereof. In various embodiments, the computing device 102 may include a storage medium 115 configured to store data in a semi-permanent or substantially permanent form. In various embodiments, the storage medium 115 may be included by the memory 114. In some embodiments, the computing device 102 may include one or more network interfaces 116 configured to associate with and communicate via one or more communication networks (e.g., a wired network, a wireless network, a cellular network, etc.). In various embodiments, the computing device 102 may include one or more other hardware components (not shown) (e.g., a display or monitor, a keyboard, a touchscreen, a camera, a fingerprint reader, a video processor, etc.).

In various embodiments, the computing device 102 may include an operating system (OS) (not shown) configured to provide one or more services to an application 118 and manage or act as an intermediary between the applications 118 and the various hardware components (e.g., the processor 112, the network interface 116, etc.) of the computing device 102. In such an embodiment, the computing device 102 may include one or more applications 118, which may be installed locally (e.g., within the storage medium 115, etc.) and configured to be executed directly by the processor 112 and directly interact with the OS. In such an embodiment, the applications 118 may include pre-compiled machine executable code. In some embodiments, the applications 118 may include a script interpreter (e.g., HTML, JavaScript, C shell (csh), AppleScript, AutoHotkey, etc.) or a virtual machine (e.g., the Java Virtual Machine, the Microsoft Common Language Runtime, etc.) that are configured to translate source or object code into executable code which is then executed by the processor 112.

In some embodiments, the application 118 may include a web browser configured to access a web site or a collection of web pages, scripts, etc. from a physically remote server or web server (e.g., business service device 104, etc.). In another embodiment, the application 118 may include a specially built program designed to interact with the business service 140 or backend portion of the application. It is understood that the above is merely one illustrative example to which the disclosed subject matter is not limited.

In various embodiments, the application 118 may be generated and executed or executed by a user interface (UI) runtime 120. In some embodiments, the UI runtime 120 or another service consumer (not shown) may not talk to the data provider 144 directly. It is talking to an intermediate layer, often consisting of the remote business service interface 140 which interprets the incoming requests and translates it into technical service operations to be orchestrated and executed by the UI runtime 142. In one embodiment, the UI 120 may communicate via, for example, Mouse Clicks, UI Control Events or end-user navigations. The UI runtime 120 may derive service operations from that and delegates these requests to the backend runtime 142 which may finally assemble/disassemble the service operations and processes the operation, aided by a Backend Service Adaptation (BSA) runtime 145, in order to join data together from the different Data Providers (BOs) 144, so that the request coming from the UI runtime 120 can be fulfilled.

In various embodiments, the system 100 may include a business service device 104. In some embodiments, the business service device 104 may include a processor 132, memory 134, and network interface 136, that are analogous to the processor 112, memory 114 (with or without the storage medium 115), and network interface 116, as described above.

In the illustrated embodiment, the business service device 104 may include a business or backend service 138 configured to receive requests from the client application 118 and provide responses (e.g., data fields 156, etc.) to such requests. In a preferred embodiment, the business service 138 may include a remote business service interface 140 configured to communicate with the application 118 or client device 102. In some embodiments, the remote backend service interface 140 may also initiate communications (e.g., various requests, etc.) with the client application 118, such that the communication may be bi-directionally initiated. It is understood that the above are merely a few illustrative examples to which the disclosed subject matter is not limited.

In one embodiment, the business service 138 may include one or more machine executable instructions. In another embodiment, the business service 138 may be embodied in a hardware device or circuit or other logic device. In various embodiments, during the runtime or execution of the business service 138 by the processor 132 (or by itself in embodiments in which the business service 138 includes hardware elements).

In various embodiments, the business service 138 may create various data structures (e.g., objects, variables, etc.). In various embodiments, these data structures may be temporary and exist only during the runtime of the business service 140. In one embodiment, some of these data structures may have permanent counterparts (e.g., classes, etc.) included by the business service 138. In some embodiments, these temporary data structures may be stored within the memory 134. In various embodiments, these data structures or a portion thereof may be referenced by or used by the business or backend runtime 142.

In one embodiment, the business service device 104 may include, at least during runtime, a service data structure or database 150. In various embodiments, this data structure 150 may include one or more data fields. These data fields may be grouped together to form larger data groups (e.g., a database entry or row). In some embodiments, the data structure 150 may be organized into, for example, a relational database, a data tree, a series of nodes, a table with columns and rows, etc. In such an embodiment, a data field may include a field, node, or cell of such a data structure. A data field may include or be associated with a data field value, a data type (e.g., integer, Boolean, string, etc.), and other attributes.

The data structures, their fields, their types, and all their characteristics (length, decimals, min/max value, etc.) may be typically described in a Metadata Repository System (MDRS). Such, in various embodiments, a MDRS may be typically filled when modeling Data Providers 144. At runtime the information stored in MDRS may be used by various runtime modules such as BSA runtime 145 and UI backend runtime 142. In such an embodiment, based on these data schema descriptions the data may be stored into business databases 180.

These business databases 180 may be hosted on one or more business data devices 106. In some embodiments, the data in these business databases 180 have been created or maintained by other business services (not shown). For example, a CRM service (business service 140) may draw data from a business database 180 created by a SCM service (not shown). It is understood that the above is merely one illustrative example to which the disclosed subject matter is not limited. In some embodiments, the business data device 106 and the business service device 104 may be the same device. In yet another embodiment, the two devices may be separate, geographically or in a network topology sense, or run by separate businesses or entities.

In one embodiment, the application 118 may be executed by a user interface (UI) runtime 120 configured to allow a user 190 to interact with the application 118 and view, edit, or delete various pieces of data (e.g., data fields 156, etc.). This Application 118 may include or be associated with a UI Model 122 that defines, at least in part, the appearance and behavior of the Application 118 on the UI. In a preferred embodiment, the UI Model 122 may be the only thing which defines the Application 118. In one embodiment, the UI Model 122 may define the data (e.g., fields, structures, and lists, etc.) of the application 118 and how they are bound to the service provider data, responds to requests for information about its state (usually from the controller), and responds to instructions to change state (usually from the controller). In such an embodiment, the UI 120 may be based upon the Model-View-Controller (MVC) software architecture in which the software logic is essentially separated into three overall functions.

In a preferred embodiment, the “model” in the MVC sense may be entirely on backend side (e.g., UI Backend Runtime 142, etc.) and it is defined in the Metadata Repository Systems (MDRS), as described below in reference to FIG. 2. It may not know anything about the controller and the view on top of it. In addition we have the UI Model. In such an embodiment, the UI Model 122 describes metadata-wise the view and the controller behavior. In some embodiments, the UI Model 122 may be stored within a UI Model Storage 143.

For instance, the UI Model 122 may define where the UI buttons are and what happens if they are clicked, which services are called by them and which UI tables are bound to the response data delivered by the services. In one specific example embodiment, in the UI Model 122 there may be a table describing in terms of layout, text formatting, column headers, grouping, sorting, and many other UI options. In addition the UI model 122 may describe what data are supposed to be shown in that table, (e.g. BO=SalesOrder, Node=SalesOrderItems, Fields=ID, deliveryDate, address, etc.). Whenever such a data set arrives at the client 102, the portion of the controller logic that resides within the UI Runtime 120 makes sure that the right table is notified and that the data are shown there.

In event-driven MVC systems, the model often notifies observers (usually views) when the information changes so that they can react. The “view” (e.g., UI runtime 120) renders the model into a form suitable for interaction, typically a user interface element. Multiple views can exist for a single model for different purposes. And, the “controller” (e.g., remote business service interface 140, UI backend runtime 142, etc.) receives user input and initiates a response by making calls on model objects. A controller accepts input from the user and instructs the model and viewport to perform actions based on that input. It is understood that the above is merely one illustrative example to which the disclosed subject matter is not limited.

In various embodiments, the UI Model 122 may include one or more definitions 124 of virtual data fields (VFs) 154. In this context a virtual data field 154 is a data field that does not exist in a business database 180, but is desired by the UI model 122 and the Application 118. In various embodiments, the VF definition 124 may define a transformation (e.g., a mathematical function, a complex script, an If-Then statement, etc.) that may be used to compute or generate a value for the VF 154. In one embodiment, the VF definition 124 may define as an input one or more non-virtual or actual data fields (AFs) 152 that do exist in a business database 180.

In such an embodiment, the VF definitions 124 may be transferred or sent to the business service device 104. In some embodiments, the transferring of each VF definition 124 may be based upon a triggering event (e.g., on loading a portion of the UI 120, Controller Implementation Point (CIP) 148, etc.). Such events are described in more detail below in reference to FIG. 2. In another embodiment, the VF definitions 124 may be transferred to the business service device 104 based upon the loading or execution of the application 118 or UI 120. In yet another embodiment, the business service device 104 of the backend runtime 142 may actively request the VF definition 124 instead of passively receiving them. It is understood that the above are merely a few illustrative examples to which the disclosed subject matter is not limited.

In one embodiment, the backend runtime 142 may include a VF generator 146. In such an embodiment, the VF generator 146 may read the VF definition 124 and dynamically generate a corresponding VF 154 according to the associated VF definition 124. Alternatively, in one embodiment, it also possible to have a static proxy generation, as described below.

In one embodiment, as data fields, specifically AFs 152, are requested as needed by the application 118, the backend runtime 142 may request these AFs 152 from their corresponding business databases 180 and cache or otherwise store the AFs 152 in the service data structure 150. As a VF 154 is requested or defined (via VF definition 124), the backend runtime 142 (e.g., via the VF generator 142) may generate or create the VF 154. As described above, in various embodiments, the VF 154 may be generated by combining one or more AFs 152 or using the AFs 152 as input to a mathematical or logical function. It is understood that the above is merely one illustrative example to which the disclosed subject matter is not limited.

In various embodiments, the VF definition 124 may include one or more of the following: assembly instructions (e.g., which may include which AFs 152 are needed to generate the VF 154), calculation instructions (e.g., how to transform the given AFs 152 into the VF 154), and data type or other attribute specifications (e.g., whether the VF 154 will be a text, date time, Boolean, amount, duration, a Product Identifier, Language Code, etc.). It is understood that the above are merely a few illustrative examples to which the disclosed subject matter is not limited.

In various embodiments, the majority of the VF definitions 124 may include relatively straight-forward transformations based upon AFs 152 or constants. However, in various embodiments, the VF definitions 124 may include more complex transformations, such as, for example, requiring additional AF data via an Application Programming Interface (API) that allows data providers 144 to interact with each other, that are based upon multiple or derivative AF 152 or service data structure 150 node instances (e.g., for doing arithmetic aggregations, a summation of filtered node values, etc.), requiring access to the UI Data Model 122 or based upon other VFs 154 (e.g., such that multi-tiered, iterative, recursive, and/or circular calculations are required), or transforming n-input fields to m-output fields, etc. It is understood that the above are merely a few illustrative examples to which the disclosed subject matter is not limited.

In various embodiments, once the VF Generator 146 has created the VF 154 it may be placed, stored, or injected within the service data structure 150. In such an embodiment, the Backend Runtime 142 may perform operations on the VFs 154 as if the VFs 154 were AFs 152. In such an embodiment, there may be no logical difference to applications or services (e.g., data provider 144, other services not shown, etc.) that make use of or receive data from the service data structure 150 between the AFs 152 and the VFs 154.

In various embodiments, the VF Generator 146 may be included by a Business Service Application (BSA) Runtime 145. In such an embodiment, the BSA Runtime 145 may include a runtime representation or interface of the various data providers 144 or in some cases to the business databases 180 directly.

In various embodiments, when the BSA Runtime 145 saves the AFs 152 back to the Business DBs 180 (e.g., if the application 118 has changed the value of an AF 152, etc.) the VFs 154 may not be saved as there is no corresponding data field in the Business DB 180, nor might the Business DB 180 have a use for the VF 154 as the VF 154 is generated generally for the use of the UI 120 and the UI model 122.

In some embodiments, Bidirectional VFs may exist. In such an embodiment, it may also be possible to save changes associated with a VF 154 to the Business DBs 180. However, the transformation 149 or CIP 148 must be capable of supporting such an operation. In such an embodiment, the VF 154 (and/or its associated transform 149 or CIP 148) may map a modification or change to the VF 154 to one or more corresponding AFs 152. For example, if a VF 154 maps a state abbreviation (e.g., MD, WA, etc.) in an AF 152 to the full name of the state (e.g., Maryland, Washington, etc.), a change in the VF 154 may be cause a change in the associated AF 152. In various embodiments, the transform 149 may include a reverse transformation operation form VF 154 to one or more AFs 152.

In one embodiment, since such a reverse transformation may not always be possible, VFs 154 may be marked accordingly in the UI model 122. In such an embodiment, non-bi-directional VFs 154 may be made read-only in the UI 120 and an attempt to write into such a VF 154 may either be ignored or lead to an exception. It is understood that the above is merely one illustrative example to which the disclosed subject matter is not limited.

An illustrative example of a VF 154 and its use by the system 100 will now be discussed. In one embodiment, the user 190 or UI 120 may desire to sort and/or filter the data fields available via the business service interface 140. In such an embodiment, the user 190 or UI 120 may want to sort and/or filter these data fields based upon a value or data field that does not actually exist in the business DB 180.

Traditionally, either this functionality would have had to have been specially built into the data provider 144. Traditionally, such a modification may mean that an additional data provider 144 would have been implemented which contains the AF equivalent of a VF in its structure and which is capable of joining the source fields together and calculate the VF equivalent AF from it. In such an embodiment, every time the UI 120 underwent a change or needed additional functionality involving a new data field, the data provider 144 would have also need to change. This would may be expensive and time consuming. Alternatively, the processing (e.g., sorting or filtering, etc.) would have to be done by the client device 102 of the UI 120. This would be inconvenient as all (or a large portion) of the service data structure 150 would have to be transferred to the client device 102 for processing (e.g., sorting or filtering, etc.) including the AFs 152 that are never shown by the UI 120 but are only needed to calculate the VFs 154. Such a transfer would be expensive in terms of bandwidth and network resources and also a possible security concern.

In the illustrated embodiment, the UI 120 or UI model 122 may specify define a VF 154 that the UI Model 122 would like injected into the service data structure 150. For example, the UI Model 122 may break the world up into 6 sales regions that do not necessarily correspond to continental or hemispheric boundaries (e.g., both Mexico and Brazil may be part of a “Latin American” region despite being in North and South America, respectively; likewise, Russia may be in a “European” region despite being partially on the continent of Asia, etc.). Nonetheless, the business DB 180 may include an AF 152 that indicates which country a sale was made in. From this country data field it may be possible to discern which sales region the data should be included in. As such, the VF definition 124 may include a transformation script that maps country codes to the VF 154 “Sales Region”.

Upon receipt of the VF definition 124 or, in various embodiments, the use of this VF 154, the VF Generator 148 may create or generate this VF 154. The BSA runtime 145 may read the indicated AFs 152 and, as dictated by the VF definition or transform 124, populate a series of VFs 154 for each entry. For example, for Sale #1 the VF Generator 154 would read the “Country Code” actual data field for Sale #1 (e.g., “MX”), apply the transform given in the VF definition 124 to generate a “Sales Region” VF for Sale #1 (e.g., “Latin America”). The VF Generator 148 would then proceed to Sale #2, read its “Country Code” actual data field (e.g., “RU”), and generate the “Sales Region” VF for Sale #2 (e.g., “Europe”). And so on for each entry in the service data structure 150. Each of these VFs for each entry may be added or injected into the service data structure 150. Doing this on device 104 and not on client device 102 may allow sorted and filtered data to be sent in packages (e.g., page-wise, etc.) depending on where the UI 120 controls have their current visibility focus (e.g. the currently visible page in a UI table, etc.).

In various embodiments, the VF Generator 148 may not create VFs 154 for each entry in the service data structure 150. In one embodiment, a filtering scheme may be applied to only add or associate VFs 154 with selected entries in the service data structure 150. For example, if the service data structure 150 is a data tree with hierarchal nodes (a.k.a. entries), in one embodiment, only the nodes below or dependent upon a certain root node may be affected. In another embodiment, the filtering may occur based upon permissions or user 190 authentication, such that VFs 154 are created only for entries that the user 190 has permission to affect. It is understood that the above are merely a few illustrative examples to which the disclosed subject matter is not limited.

Continuing the illustrative example, at some point in the user 190's operation of the application 118, the application 118 may request all sales data for the “Europe” sales region. In such an embodiment, the Backend Runtime 142 may include a Data Provider 144 configured to fulfill data requests from the application 118. In one embodiment, the UI Backend Runtime 142 may query the Service Data Structure 150 for any entries that that include a “Sales Region” data field having a value equal to “Europe”. It is noted that in this embodiment, the UI Backend Runtime 142, or even the BSA Runtime 145, may, in some usage cases (e.g., filtering operations, etc.), be relatively ignorant or uncaring as to whether or not the “Sales Region” data fields are actual data fields 152 or virtual data fields 154. As such the VF 154 may act or appear to users or consumers of the data provided by the service data structure 150 as simply “normal”, non-virtual data fields. In such an embodiment, once the UI Backend Runtime 142 has performed the requested filtration operation, the resultant entries or data fields 156 may be transmitted to the application 118 or client device 102. In various embodiments, the UI Backend Runtime 142, or the BSA Runtime 145, may be relatively aware that a data field is a VF 154 for certain usage cases or options (e.g., when filling or setting value within the VF 154, for example, via a transform 149 or CIP 148, etc.).

In another embodiment, the application 118 may request all sales data sorted by sales region. In one embodiment, the UI Backend Runtime 142 may query the Service Data Structure 150 for any pertinent entries and then example the entry's “Sales Region” data field (e.g., VF 154) to perform the sorting operation. In such an embodiment, the UI Backend Runtime 142 may examine any attributes associated with the data field (e.g., data type, etc.) to determine how to perform the sorting operation (e.g., dates may be sorted differently than pure text, etc.). In such an embodiment, once the UI Backend Runtime 142 (or in some embodiments even business data device 106, etc.) has performed the requested sorting operation, the resultant entries or data fields 156 may be transmitted to the application 118 or client device 102. In various embodiments, if the amount of returned data fields 156 are large (e.g., above a threshold value, etc.) the UI Backend Runtime 142 may transmit the data fields 156 in groups, portions or pages. In some embodiments, these groups, portions, or pages may be transmitted to the client device 102 on demand or as requested. It is understood that the above are merely a few illustrative examples to which the disclosed subject matter is not limited.

In various embodiments, the VF 154 may be based upon an AF 152 that is not transmitted to the client device 102 or included in the data fields 156. In such an embodiment, AF 152 may be acquired from the business DB 180 and stored within the service data structure 150. It is understood that the above is merely one illustrative example to which the disclosed subject matter is not limited.

In some embodiments, the VF Generator 146 may employ one or more techniques for injecting the VF 154 into the service data structure 150. In one embodiment, the VF Generator 146 may create a new VF 154 dynamically at runtime once per user session. In such an embodiment, the VF 154 structure may not be visible in any type dictionary but only in existence at runtime. In another embodiment, VF Generator 146 may create a new VF 154 dynamically at runtime and put it into a shared memory so that it can be reused by other user sessions. In yet another embodiment, VF Generator 146 may create a new proxy VF 154 structure at UI activation time. In such an embodiment, this proxy data field structure may be visible in the backend data type dictionary 150 the same way as any other non-virtual data field structure. It is understood that the above are merely a few illustrative examples to which the disclosed subject matter is not limited.

In various embodiments, the UI 120 and/or the UI model 122 may be defined by a UI designer or Administrator 192. In such an embodiment, the Administrator 192 may use an administrator device 108, which in some embodiments may be the client device 102 or the business service device 108. In some embodiments, the administrator device 108 may include a processor, memory, and/or network interface (not shown) that are analogous to the processor, memory and network interface as described above in reference to the client device 102.

In various embodiments, the disclosed subject matter may allow consumers of data services to, among other things: extend backend data services without modifying them, introduce new data fields on data service inbound (e.g. data query input parameters) as well as on outbound (e.g., data query response data) side, do this service extensions model-driven and not via re-coding or via specific custom functions. In various embodiments, the metadata which describes the consumer extensions may be interpreted by the backend framework and the service interface may be extended either at runtime, deploy/install time, first usage time, or compilation time. In some embodiments, the interface extensions may be filled by an appropriate backend framework at runtime, according to the instructions given in the consumer model.

In various embodiments, due to constraints such as, for example, performance and memory consumption, the interpretation of the Virtual Fields (which may be described in the consumer model) may not be located at one central place inside the service provisioning and adaptation framework. Instead, the model may be self-describing also in a sense that it defines how (e.g., which functional units will fill the VFs) and where (e.g., in which software layer) will be filled, as described below in reference to FIG. 2.

In some embodiments, Virtual Fields may not only be meant to support read scenarios but also write scenarios. Depending on whether the functional unit that is related to a VF supports both directions (e.g., bi-directional) or not the consumer model can use VFs for either scenario. In such an embodiment, VFs may be derived from AFs and also the other way around, that is, for bi-directional VFs, AFs may be derived from VFs.

FIG. 2 is a block diagram of an example embodiment of a system 200 in accordance with the disclosed subject matter. In the illustrated embodiment, the lifecycle of the different layers or components employed in defining, creating, and using the virtual data fields are shown.

In the illustrated embodiment, the elements UI Designer 202 and client 204 may represent frontend components of the system 200, whereas the elements 206, 208, 210, 212, 214, 216, and 218 may generally represent backend components of the system 200 (illustrated by the horizontal dashed line). Also, in the illustrated embodiment, the elements 202, 206, 210, and 214 may generally represent design time or metadata components of the system 200, whereas the elements 204, 208, 212, 216, and 218 may generally represent runtime components of the system 200 (illustrated by the vertical dashed line).

In one embodiment, the user interface (UI) Designer 202 may be employed to create or define a UI Model 206. In such an embodiment, a user (not shown) may use the UI Designer 202 to indicate that the UI will may use of one or more actual data fields 240 (e.g., data fields A1, A2, B1, and B2, etc.) and may also make use of a virtual data field 242 (e.g., VF, etc.). The UI Designer 202 may indicate that VF 242 is defined by a transform or function that takes actual data fields A3 and B3 as inputs. As described above, in various embodiments, the definition of the VF may include other functions or transformative operations, such as, for example, constants, lookup tables, etc. In the illustrated embodiment, the data fields are shown as a tabular data structure organized into entries (rows) and data fields (columns). It is understood that the above is merely one illustrative example to which the disclosed subject matter is not limited.

In such an embodiment, once the system 200 is executed by a processor or other device (e.g., a custom circuit, etc.) or otherwise enters a runtime state the UI defined by the UI Designer 202 may instantiate the UI Model 206. Again, in various embodiments, the system 200 may employ a Model-View-Controller (MVC) architecture. However, in other embodiments, other architectures are possible. In such an embodiment, the UI Model 206 may include the definition 244 for the virtual data field. In some embodiments, the VF definition 244 may include a Controller Implementation Point (CIP) portion 246 and a transform portion 248, as described below.

In various embodiments, the UI Model 206 may provide information to the client 204, which during runtime may be embodied or instantiated at the UI Runtime 208. In such an embodiment, the UI Runtime 208 may include the View and Controller aspects of the MVC architecture. In such an embodiment, the UI Runtime 208 may include a Controller Implementation Point (CIP) 246 associated with the virtual data field 242. In various embodiments, this CIP 246 may be included or defined by the VF definition 244, but may be evaluated and executed by the UI Runtime 208.

In various embodiments, a CIP 246 may include a definition or function that may result in the creation of the VF 242 and the injection of the VF 242 into the service data structure (illustrated a database 248). In another embodiment, CIP 246 may be described as a code breakout that is supposed to be used for adapting core services of actual data fields according to the needs of the scenario the UI is built for. In various embodiments, the CIP 246 may include a script that defines when or upon the occurrence of a given event the VF 242 is to be created etc. In various embodiments, the CIP 246 may be evaluated by a Controller aspect of the MVC architecture (e.g., an event handler, etc.). Like for transformations 248, described below, the CIP 246 may be provided with or include the required inbound data fields as defined in the UI model 206. It may then be called in one of the above described ways and returns the result so that it can be placed into the VF 242 (e.g., by the UI Runtime 208).

In various embodiments, Transformations 248 may be designed to have a reuse character with their metadata stored in a MDRS 214. For example, an AF 240 may include a DateTime but a user/designer may desire a Duration VF 242. The user can search the MDRS 214 (or other transformation 248 storage entity) for a Transformation 248 that defines the transform of the DateTime AF 240 into the Duration VF 242. In MDRS 214 each Transformations 248 may be, in various embodiments, classified and categorized according to their tasks (e.g. for query input or query results, bidirectional or not, n-to-m vs. 1-to-n conversions, etc.). If one does not find a suitable Transformation 248, one can program their own and expose it into the metadata repository (e.g., MDRS 214, etc.). In such an embodiment, such a transformation 248 may need to be programmatically implemented in a programming language the same way as a CIP 246.

In another embodiment, if one decides that their AF-to-VF transformation is very specific to their use case, scenario, business domain, or very complicated, or requires various API calls, so that it is not recommendable or, in one embodiment, not even possible to put it into a transformation 248, then one may decide to create a CIP 246. In such an embodiment, there may be much less metadata about a CIP 246 than about a Transformation 248. In various embodiments, there may not be information stored in the MDRS 214 about the CIP 246.

In various embodiments, in the UI Model 206 it may be described at which point of time there a CIP 246 to be called. In such an embodiment, it may be up to the CIP 246 (or the UI Runtime implementation or execution of the CIP 246) to read the defined AFs 240 and fill the appropriate VFs 242 based upon the CIP 246. In various embodiments, no additional metadata may be exposed and no reuse may be allowed. In one embodiment, the CIP 246 may be implemented using a predefined API which it can use to read/write data to the UI fields.

In various embodiments, the CIP 246 may act as a UI event handler which can be represented by different operations, such as, one or more of the following examples: An OnParameterLoad CIP that may be called when the action or query parameters get loaded by the UI. An OnDataLoad CIP that may handle the loading of dedicated fields and nodes. An OnAction CIP for handling of Controller Actions. An OnValueHelp CIP for handling of dynamic code lists and/or dedicated identifier fields. An OnBeforeDataChange CIP for handling of a reaction to data change event before core services are called. An OnBOChanged CIP for reacting on core data field changes. In such an embodiment, an entry or data field may be referred to as a business object (BO). An OnAssociationLoad CIP to create and implement associations in the UI Data Model 244 for use cases where no associations in the underlying core data fields exist. Such a CIP may determine the links of the association. An OnNavigation CIP to implement a dynamic data field or node target resolution. In these cases the belonging event handling CIP may be called which then can calculate and fill the VFs that have been injected into the service data structure. It is understood that the above are merely a few illustrative examples to which the disclosed subject matter is not limited.

In the illustrated embodiment, the VF definition 244 may be translated to or incorporated into a Service Adaptation Description Language (SADL) 210 that is configured to be easily transmitted and provide a description of the data fields used by the UI Model 206 and UI in general. In various embodiments, the SADL may include or be formatted in a text document such as Extensible Markup Language (XML). It is understood that the above is merely one illustrative example to which the disclosed subject matter is not limited.

In various embodiments, UI Runtime 208 and Business Service Application (BSA)/SADL Runtime 212 may be a split controller within the MVC where only the UI Runtime 208 knows the UI fields and the UI events whereas only the BSA/SADL Runtime 212 may know the underlying native services which need to be assembled together in order to deliver the data as defined in the UI model 206. In such an embodiment, one UI data structure may potentially originate from different data providers (BOs). Based on the SADL, the BSA may do all the joining work. In addition, in various embodiments, the BSA may reserve correctly typed placeholders for the VFs into the service data structure. In such an embodiment, both parts together (UI Runtime 208 and BSA/SADL Runtime 212) may form the backend controller.

This SADL 210 may then be consumed or processed by the Business Service Application (BSA)/SADL Runtime 212. In various embodiments, this BSA/SADL Runtime 212 may be similar to the Backend Runtime 142 of FIG. 1. In the illustrated embodiment, the BSA/SADL Runtime 212 may be configured to generate the VF 242 by employing the transform 248 portion of the VF definition 244. In the illustrated embodiment, the values of the VF 244 (and hence the VF 244 itself) may be created by computing the result of a function whose input is the two actual data fields A3 and B3. In various embodiments, whenever the UI is launched and the SADL 210 is generated, the BSA/SADL Runtime engine 212 may create a virtual service response structure which has the Virtual Field injected. In such an embodiment, for consumers of this service it may not matter whether a particular field is an actual one or a virtual one. In some embodiments, the standard data field metadata load generation may be aware of such Virtual Fields 242 as well.

In various embodiments, the BSA/SADL Runtime 212 may add or acquire the desired or needed actual data fields (e.g., A1, A2, A3, etc.) from one or more Business Object (BO) Services 216. In addition, corresponding BO Models or Metadata Repository Systems (MDRS) 214 may be associated with the BO Services 216. In one embodiment, the MDRS 216 may include data field dictionaries or other metadata 252 that describes one or more attributes (e.g., data type, etc.) associated with the data fields provided by the BO Services 216. In various embodiments, the BO Services 216 and the MDRS 214 may correspond to the Backend Databases 180 of FIG. 1. It is understood that the above is merely one illustrative example to which the disclosed subject matter is not limited.

In one embodiment, as the BSA/SADL Runtime 212 requests various data fields from the BO Services 216 these data fields may be stored, at least temporarily, in the database (DB) 218. In various embodiments, the DB 218 may include a subset of the data fields 250 available via the BO Services 216. As described above, as VFs 242 are created, the VFs 242 may be injected within this runtime DB 218. In such an embodiment, the BSA 212 may not go through the BO services 216 to fetch the data but may delegate the data request to the DB 218 directly. A prerequisite for this kind of shortcut may be that the UI scenario works with persistent DB data and not with transient/transactional data (e.g., write scenarios, etc.). The transactional data may be kept inside the BO services 216. In some embodiments, the VFs 242 may have no corresponding metadata associated with them in the MDRS 214. However, in various embodiments, the DB 218 may include its own temporary metadata structure that may include references to the VFs 242. In such an embodiment, the data fields of the SADL 206 and native data fields (e.g., from the BO Services 216, etc.) may support a unique or uniform metadata API. In such an embodiment, consumers that do not only use data services of these VFs 242 but also metadata APIs will get this virtual field 242 and its type information or other metadata as if it was any other data field.

In some embodiments, a technical vehicle for implementing DB-sided transformations may include so-called ‘stored procedures’. However, the VFs may never be persisted on DB side, but the DB may create and append some kind of shadow columns in case the select statement is formulated accordingly. In such an embodiment, the shadow columns may be where it places the results from the stored procedures. It can then do sorting/paging directly on the entire result set regardless whether the sort criteria are applied to a shadow column or to a real column.

In some embodiments, some forms of metadata or attributes may include Input Help Query information from or in the UI Designer 202 data model. Therefore for Identifier (ID) fields the data model may include a value help query properties, such as, for example, BO Name, BO Node Name and Query. These attributes or properties may either be specified directly in the data model, or, in various embodiments, may be derived automatically based upon the data field being used in the view control which displays the ID field. It is understood that the above is merely one illustrative example to which the disclosed subject matter is not limited.

In various embodiments, some Virtual fields 242 may need or include some features of MDRS 214. In some embodiments, a dynamic value help setting may be specified in the MDRS 214 and a corresponding core service implementation may exist in other Service Providers. In one such embodiment, in order to support a backend based dynamic value help the UI Data Model 206 may include the Event OnValueHelp to register and implement a dynamic value help CIP 246 Event Handler implementation which may be executed in a backend portion as soon as a user of the system 200 requests input help on such a field.

As the time comes to save the data fields from the DB 218, the actual data fields 254 that have corresponding members in the BO Services 216 data structures (e.g., A1, A2, A3, etc.) may be saved back to the respective BO Services 216. Likewise, in some embodiments, any associated metadata may be saved back to the MDSR 214.

However, in a preferred embodiment, the MDRS data may never modified/save at runtime. In such an embodiment, the MDRS may include pure design time metadata filled by a BO-Designer-Tool. An example of another embodiment, in which the MDRS is saved may include if the service data structure is compiled via a form of so-called proxy structures, these proxy structures could be saved in the MDRS, potentially at the point of time when the UI is called for the first time, which may then be more or less the runtime. But normally one would keep these UI specific proxies separate from the data service specific proxies and would introduce separate metadata storage for them.

However, as a data field generated primarily for the use of the UI (although, other uses may occur), the VFs 242 are not saved back directly to the BO Services 216. In various embodiments, explicit bi-directional CIP or transformation capabilities as described in previous sections may allow for VF data or data derived from a VF to be saved to the BO Services 216. In this case the CIPs/transformations may be processed in a reverse direction. As described above, in such an embodiment, the VF that has been modified in the UI may be transformed into modified AFs. It is understood that this may not be possible in all cases, and CIPs and transformations which are bi-directional may need to be marked as such.

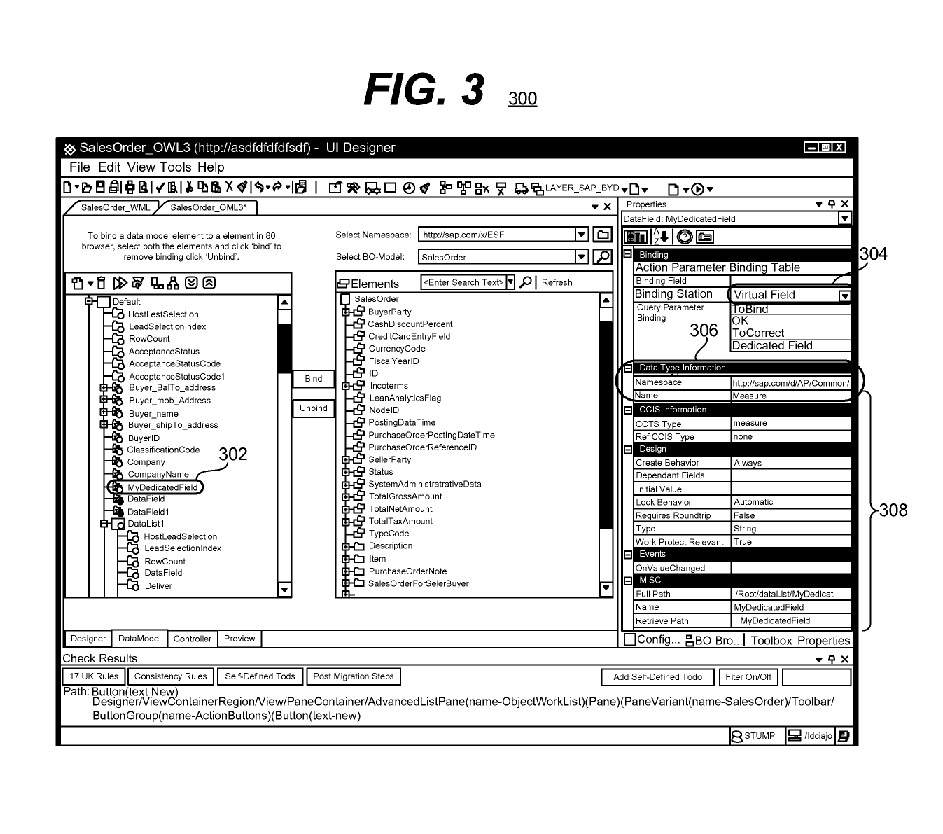

FIG. 3 is a screenshot of an example embodiment of a user interface (UI) 300 in accordance with the disclosed subject matter. In one embodiment, the user interface 300 may be employed by a UI Designer (e.g., Administrator 192 of FIG. 1, UI Designer 202 of FIG. 2, etc.) to define a virtual field (VF) 302 for use in a system that embodies the disclosed subject matter.

In the illustrated embodiment, a VF 302 may be defined via the UI 300. The VF 302 may be given a name, such as, MyDedicatedField. In one such embodiment, the UI designer may be able to specify that the new data field is a “Virtual Field” via UI element 304. In the illustrated embodiment, UI element 304 is a pull-down menu that allows a user or UI designer to dictate the binding of the data field (e.g., “Virtual Field”, etc.).

In the illustrated embodiment, the user or UI designer may be able to use UI element 306 to specify the data type and, in various embodiments, the namespace for which the data field 302 is valid for. In such an embodiment, various data fields may have different namespaces or scopes (e.g., local, global, etc.) in which the data field is valid. In another embodiment, the namespace may indicate another file or data structure (e.g., header file, dictionary, XML schema, etc.) that specifics or defines a list of valid data types (e.g., “Measure”, etc.). It is understood that the above are merely a few illustrative examples to which the disclosed subject matter is not limited.

In the illustrated embodiment, the user or UI designer may be able to use UI elements 308 to define or set other various attributes or metadata (e.g., Dependent Fields, Initial Value, Events, Create Behavior, etc.) associated with the data field 302. It is understood that the above are merely a few illustrative examples to which the disclosed subject matter is not limited.

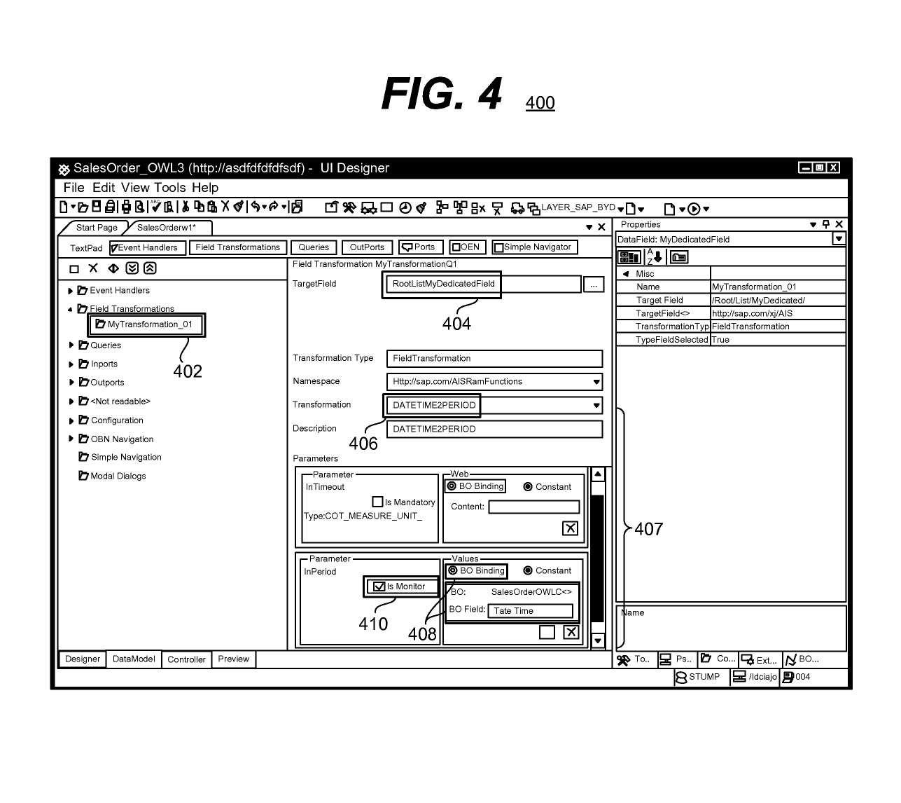

FIG. 4 is a screenshot of an example embodiment of a user interface (UI) 400 in accordance with the disclosed subject matter. In one embodiment, the user interface 400 may be employed by a UI Designer (e.g., Administrator 192 of FIG. 1, UI Designer 202 of FIG. 2, etc.) to define a transformation 403 for use in a system that embodies the disclosed subject matter.

In such an embodiment, a user of UI designer may define, edit or create a transformation 402 (e.g., MyTransformation_{—}01, etc.). In various embodiments, the transformations may be separate from but associated with the virtual fields. In such an embodiment, transformations may be easily re-used or shared amongst multiple virtual fields or multiple UIs. In another embodiment, each transformation may be included in or tightly coupled with a respective virtual field. It is understood that the above are merely a few illustrative examples to which the disclosed subject matter is not limited.

In various embodiments, the user or UI designer may be able to use UI element 404 to specify which virtual field or fields are associated with the transformation. In another embodiment, a virtual field defining UI (e.g., UI 300, etc.) may allow a user to associate the virtual field with a transformation (e.g., via a virtual field attribute, etc.). It is understood that the above are merely a few illustrative examples to which the disclosed subject matter is not limited.

In some embodiments, the user or UI designer may be able to use UI element 406 to specify the saved function, programmatic method, subroutine or script to execute when performing the transformation 402. In various embodiments, the UI element 406 may simply be the name of the transformation under which it is stored in the MDRS. In such an embodiment, the UI element 407 may allow the user or UI designer to specify which values (e.g., constants, actual data fields, etc.) are to be provided as parameters or inputs to the function/transformation specified via UI element 406. UI elements 408 may allow a user or UI designer to specify or bind a given actual data field to the transformation. In various embodiments, the UI element 410 may allow a user or UI designer specify whether or not a given parameter is mandatory or optional for the function/transformation specified via UI element 406. It is understood that the above are merely a few illustrative examples to which the disclosed subject matter is not limited.

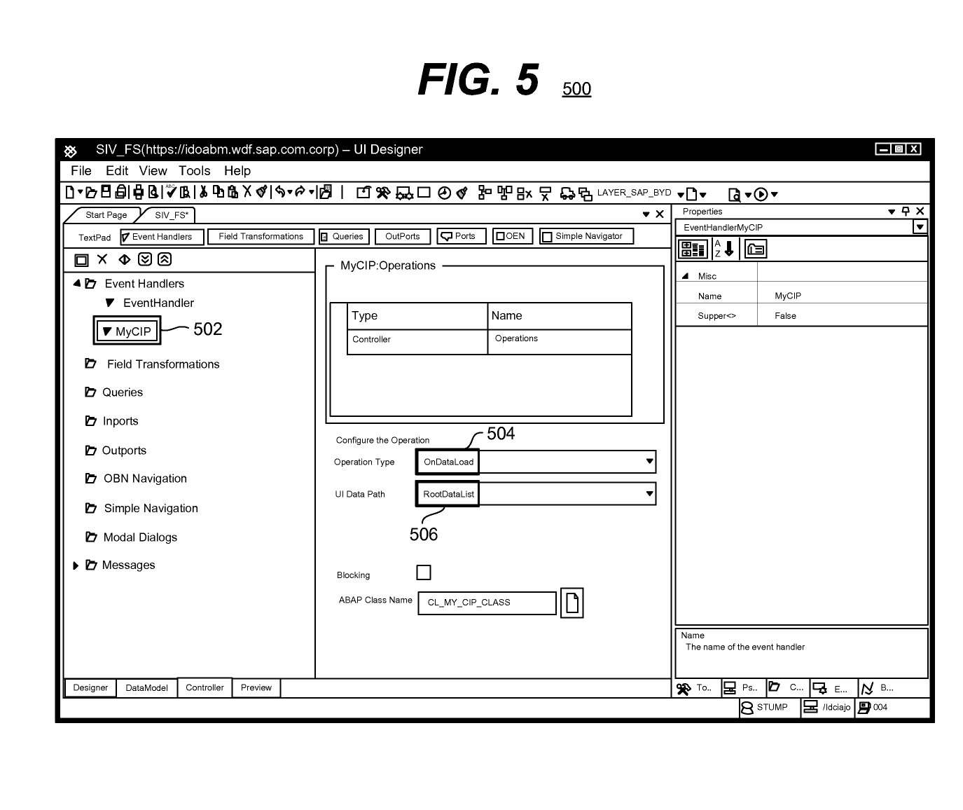

FIG. 5 is a screenshot of an example embodiment of a user interface (UI) 500 in accordance with the disclosed subject matter. In one embodiment, the user interface 500 may be employed by a UI Designer (e.g., Administrator 192 of FIG. 1, UI Designer 202 of FIG. 2, etc.) to define a Controller Implementation Point (CIP) 502 for use in a system that embodies the disclosed subject matter.

In such an embodiment, a user of UI designer may define, edit or create a CIP 502 (e.g., MyCIP, etc.). In various embodiments, the CIPs may be separate from but associated with the virtual fields. In some embodiments, CIPs may be easily re-used or shared amongst multiple virtual fields or multiple UIs, similarly to Transformations, as described above. In another embodiment, each CIP work with virtual fields, e.g. the CIP may calculate their values from AFs It is understood that the above are merely a few illustrative examples to which the disclosed subject matter is not limited.

In various embodiments, the UI element 504 may allow a user or UI designer to specify the event or operation that will trigger the CIP 502. UI element 506 may, in some embodiments, allow the user or UI designer to specify which UI field the CIP 402 is associated with. In some embodiments these UI fields may be virtual data fields. Likewise, in various embodiments, the virtual data field definition may include an attribute or metadata that associates the virtual field with a given CIP. It is understood that the above are merely a few illustrative examples to which the disclosed subject matter is not limited.

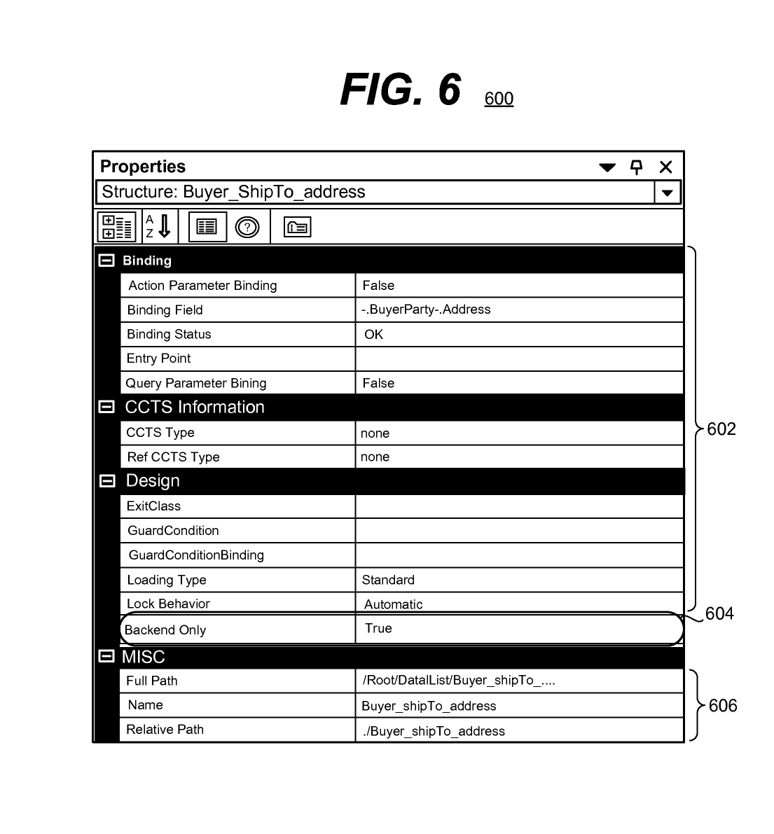

FIG. 6 is a screenshot of an example embodiment of a user interface (UI) 600 in accordance with the disclosed subject matter. In one embodiment, the user interface 600 may be employed by a UI Designer (e.g., Administrator 192 of FIG. 1, UI Designer 202 of FIG. 2, etc.) to define one or more attributes or pieces of metadata associated with a data field for use in a system that embodies the disclosed subject matter. In the illustrated embodiment, the metadata for an actual data field is shown.

In various embodiments, it may be possible to define or specify data fields that have a proper BO node attribute binding but are not meant to be transported to client side. In such an embodiment, these data fields may be used (sometimes exclusively used) within or for various CIP's. In another embodiment, these data fields may be transported to the client side, but are not intended to be displayed to the user. It is understood that the above are merely a few illustrative examples to which the disclosed subject matter is not limited.

In such an embodiment, the UI 600 may include or show attributes 602 that specify the name and other identifying attributes or metadata of the data field (e.g., full path, relative path, etc.). The UI 600 may also include or show attributes 606 that specify other metadata or attributes about or associated with the data field (e.g., binding status, entry point, exit class, loading behavior, etc.). The UI 600 may further include a Backend Only attribute, property, or metadata 604 that indicates whether or not the data field is to be transported to the client side and/or displayed to the user, depending upon the embodiment. In various embodiments, these two actions may be represented as multiple attributes 604. In some embodiments, the attribute may include various levels of client side interaction as opposed to a binary value. In some embodiments this Backend Only setting may be typically used for input fields (AFs) for CIPs and Transformations which calculate VFs but may not be needed otherwise on the UI. It is understood that the above are merely a few illustrative examples to which the disclosed subject matter is not limited.

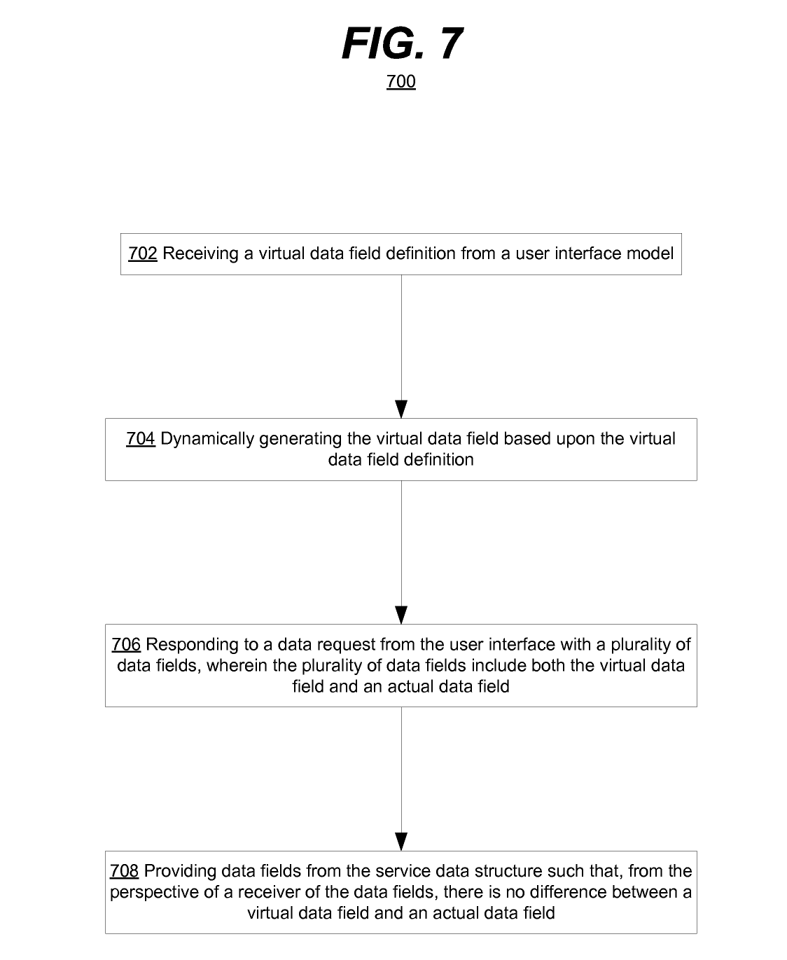

FIG. 7 is a flowchart of an example embodiment of a technique 700 in accordance with the disclosed subject matter. In various embodiments, the technique 700 may be used or produced by the systems such as those of FIGS. 1 and 2. Furthermore, portions of technique 700 may be used or produced by the user interfaces such as that of FIG. 3, 4, 5, or 6. Although, it is understood that the above are merely a few illustrative examples to which the disclosed subject matter is not limited. It is understood that the disclosed subject matter is not limited to the ordering of or number of actions illustrated by technique 700.

Block 702 illustrates that, in one embodiment, a virtual data field definition may be received from a user interface model, as described above. In various embodiments, the virtual data field may include a data field does not have a counterpart in a database of actual data fields, as described above. In some embodiments, the actual data field from which the virtual data field is generated may include an attribute indicating that the actual data field is not to be provided to the user interface, as described above. In one embodiment, receiving may include receiving the virtual data field definition on the occurrence of an event associated with the virtual data field definition, as described above. In another embodiment, receiving a virtual data field definition may include receiving the virtual data field definition when the user interface is launched by a client device, as described above. In various embodiments, one or more of the action(s) illustrated by this Block may be performed by the apparatuses or systems of FIG. 1 or 2, the business service device 104, processor 132, or network interface 136 of FIG. 1, as described above.

Block 704 illustrates that, in one embodiment, the virtual data field may be dynamically generated based upon the virtual data field definition, as described above. In various embodiments, dynamically generating may include injecting the virtual data field into a service data structure, as described above. In some embodiments, dynamically generating may include generating each virtual data field once per runtime session, as described above. In another embodiment, generating may include generating each virtual data field as a static proxy at UI model storage or activation, as described above. In various embodiments, dynamically generating may include generating, according to the virtual data field definition, the virtual data field based upon at least one actual data field, as described above. In various embodiments, one or more of the action(s) illustrated by this Block may be performed by the apparatuses or systems of FIG. 1 or 2, the business service device 104, processor 132, or network interface 136 of FIG. 1, as described above.

Block 706 illustrates that, in one embodiment, a response to a data request from the user interface may occur that includes with a plurality of data fields, as described above. In such an embodiment, the plurality of data fields may include both the virtual data field and an actual data field included by the database, as described above. In various embodiments, responding to the data request may include sorting the plurality of data fields based, at least in part, upon the virtual data field, and providing, at least a portion of, the sorted plurality of data fields to the user interface, as described above. In various embodiments, one or more of the action(s) illustrated by this Block may be performed by the apparatuses or systems of FIG. 1 or 2, the business service device 104, processor 132, or network interface 136 of FIG. 1, as described above.

Block 708 illustrates that, in one embodiment, data fields may be provided from the service data structure such that, from the perspective of a receiver of the data fields, there is no difference between a virtual data field and an actual data field, as described above. In various embodiments, one or more of the action(s) illustrated by this Block may be performed by the apparatuses or systems of FIG. 1 or 2, the business service device 104, processor 132, or network interface 136 of FIG. 1, as described above.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer (e.g., a mobile device, tablet, laptop, netbook, desktop computer, etc.) having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

1. A method comprising:
receiving a virtual data field definition stored in a user interface model, wherein the user interface model defines, at least in part, an appearance and a behavior of a user interface of an application, wherein the virtual data field includes a data field that does not have a counterpart in a database of actual data fields;
dynamically generating the virtual data field based upon the virtual data field definition; and
responding to a data request from the user interface with a plurality of data fields, wherein the plurality of data fields include both the virtual data field and an actual data field included by the database.

2. The method of claim 1, wherein dynamically generating includes injecting the virtual data field into a service data structure.

3. The method of claim 2, further comprising providing data fields from the service data structure such that, from a perspective of a receiver of the data fields, there is no difference between a virtual data field and an actual data field.

4. The method of claim 1, wherein dynamically generating includes generating each virtual data field once per runtime session.

5. The method of claim 1, wherein responding to the data request includes: sorting the plurality of data fields based, at least in part, upon the virtual data field, and providing, at least a portion of, the plurality of data fields to the user interface.

6. The method of claim 1, wherein dynamically generating includes generating, according to the virtual data field definition, the virtual data field based upon at least one actual data field.

7. The method of claim 6, wherein the actual data field from which the virtual data field is generated, includes an attribute indicating that the actual data field is not to be provided to the user interface.

8. The method of claim 1, wherein receiving a virtual data field definition includes receiving the virtual data field definition on an occurrence of an event associated with the virtual data field definition.

9. The method of claim 1, wherein receiving a virtual data field definition includes receiving the virtual data field definition when the user interface is launched by a client device.

10. An apparatus comprising:
a network interface configured to receive a virtual data field definition stored in a user interface model, wherein the user interface model defines, at least in part, an appearance and a behavior of a user interface of an application, wherein the virtual data field includes a data field that does not have a counterpart in a database of actual data fields; and
a processor configured to:
dynamically generate the virtual data field based upon the virtual data field definition, and
respond to a data request from the user interface with a plurality of data fields, wherein the plurality of data fields include both the virtual data field and an actual data field included by the database.

11. The apparatus of claim 10, wherein the processor is configured to inject the virtual data field into a service data structure included by the apparatus.

12. The apparatus of claim 11, wherein the processor is configured to provide data fields from the service data structure such that there is no difference between a virtual data field and an actual data field.

13. The apparatus of claim 10, wherein the processor is configured to generate a virtual data field from a static proxy during a user interface runtime activation.

14. The apparatus of claim 10, wherein the processor is configured to:
sort the plurality of data fields based, at least in part, upon the virtual data field, and provide, at least a portion of, the sorted plurality of data fields to the user interface.

15. The apparatus of claim 10, wherein the processor is configured to generate the virtual data field, according to the virtual data field definition, the virtual data field based upon at least one actual data field.

16. The apparatus of claim 15, wherein the actual data field from which the virtual data field is generated, includes an attribute indicating that the actual data field is not to be provided to the user interface.

17. The apparatus of claim 10, wherein the network interface is configured to receive the virtual data field definition on an occurrence of an event associated with the virtual data field definition.

18. The apparatus of claim 10, wherein the network interface is configured to receive the virtual data field definition in response to the user interface being launched by a client device.

19. A computer program product for providing information, the computer program product being tangibly and non-transitorily embodied on a computer-readable medium and including executable code that, when executed, is configured to cause a data processing apparatus to:
receive a virtual data field definition stored in a user interface model, wherein the user interface model defines, at least in part, an appearance and a behavior of a user interface of an application, wherein the virtual data field includes a data field that does not have a counterpart in a database of actual data fields;
dynamically generate the virtual data field based upon the virtual data field definition; and
respond to a data request from the user interface with a plurality of data fields, wherein the plurality of data fields include both the virtual data field and an actual data field included by the database.

20. The computer program product of claim 19 wherein the executable code that, when executed, is configured to cause a data processing apparatus to:
provide data fields from a service data structure such that, from a perspective of a receiver of the data fields, there is no difference between a virtual data field and an actual data field.
